(19) United States
(12) Patent Application Publication
(10) Pub. No.: US 2026/0250938 A1
(43) Pub. Date: Aug. 27, 2026

(54) DRAIN LINE ALERT DEVICE

(71) Applicants: Jim Kuhlmann, Benton, AR (US); Jayce Jones, Little Rock, AR (US); Arghya Sadhukhan, Kolkata (IN); Suchitran Das, Kolkata (IN)

(72) Inventors: Jim Kuhlmann, Benton, AR (US); Jayce Jones, Little Rock, AR (US); Arghya Sadhukhan, Kolkata (IN); Suchitran Das, Kolkata (IN)

(21) Appl. No.: 19/061,090

(22) Filed: Feb. 24, 2025

(51) Int. Cl. E03F 7/00; G08B 21/18

(52) U.S. Cl. CPC E03F 7/00; G08B 21/182; E03F 2201/40

(57) ABSTRACT

A drain line alert device for preventing overflow of wastewater in a sewer line by detecting when the sewer line is full and notifying the user to stop running water. The device includes an enclosure cover, a printed circuit board, an enclosure housing, a plumbing fitting clean out plug, and a base with a plurality of sensor prongs.

### CROSS-REFERENCE TO RELATED APPLICATIONS

Not applicable

### STATEMENT REGARDING FEDERALLY SPONSORED RESEARCH OR DEVELOPMENT

Not applicable.

### BACKGROUND OF THE INVENTION

The present invention generally relates to the field of wastewater management and specifically to a device and method for preventing overflow in sewer lines.

### BRIEF SUMMARY OF THE INVENTION

The present invention is directed to a drain line alert device for sending electronic messages to alert for drain line stoppage. The present invention is also directed to a drain line alert device for preventing overflow of wastewater in a sewer line by detecting when the sewer line is full and notifying the user to stop running water. The device includes an enclosure cover, a printed circuit board, an enclosure housing, a plumbing fitting clean out plug, and a base with a plurality of sensor prongs. The drain line alert device of the present invention is wireless and autonomous.

These and other features, objects and advantages of the present invention will become better understood from a consideration of the following detailed description of the preferred embodiments and appended claims in conjunction with the drawings as described following:

### BRIEF DESCRIPTION OF DRAWINGS

FIG. 1 is an exploded view of the drain line alert device.

FIG. 2 is a top view of the printed current board of the device.

FIG. 3 is a perspective view of the enclosure cover and enclosure housing of the device.

FIG. 4 is a side view of the device showing the sensor prongs.

FIG. 5 is a bottom view of the plumbing fitting clean out plug and the base of the device.

FIG. 6 is a closeup bottom view of the plumbing fitting clean out plug and the base of the device.

FIG. 7 is a bottom view of the plumbing fitting clean out plug of the device showing the sensor prongs.

FIG. 8 is a top view of the device with the enclosure cover removed and the batteries omitted.

FIG. 9 is a top view of the device with the enclosure cover removed.

FIG. 10 is a diagram showing the connection between the device and a router.

FIG. 11 is a transparent side view of the device when water backs up.

FIG. 12 is a front view of a smart device receiving an alert sent by the device when a blockage is detected.

FIG. 13 is a side view of the device installed on a typical plumbing fitting.

FIG. 14 is a bottom view of the plumbing fitting clean out plug of the device showing all of the sensor prongs.

FIG. 15 is a perspective view of the enclosure cover, enclosure housing, and plumbing fitting clean out plug of the device.

FIG. 16 is a top view of the device with the enclosure cover removed.

FIG. 17 is an exploded view of the device with the batteries omitted.

### DETAILED DESCRIPTION OF THE INVENTION

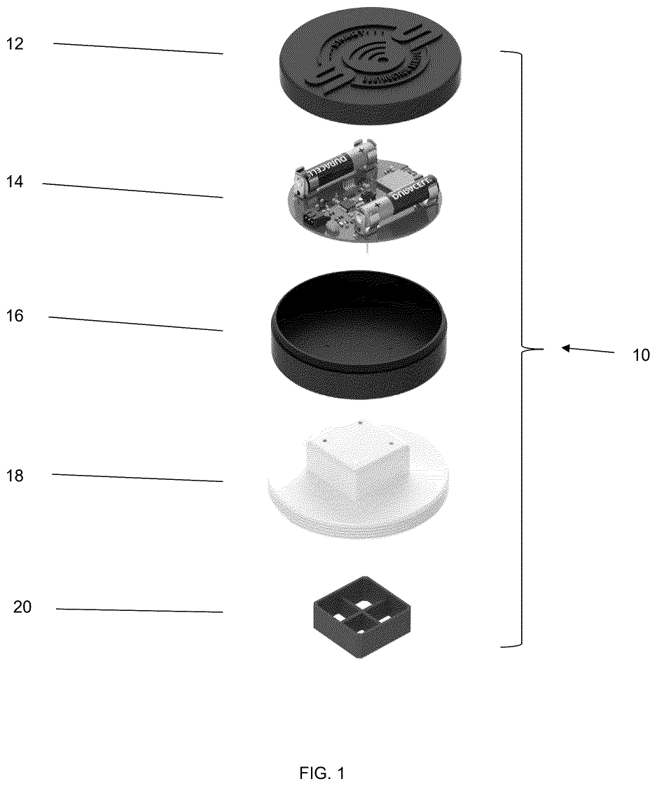

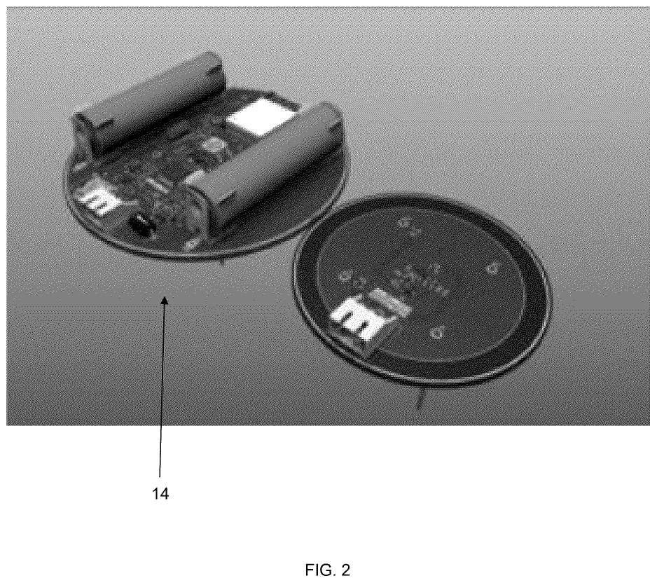

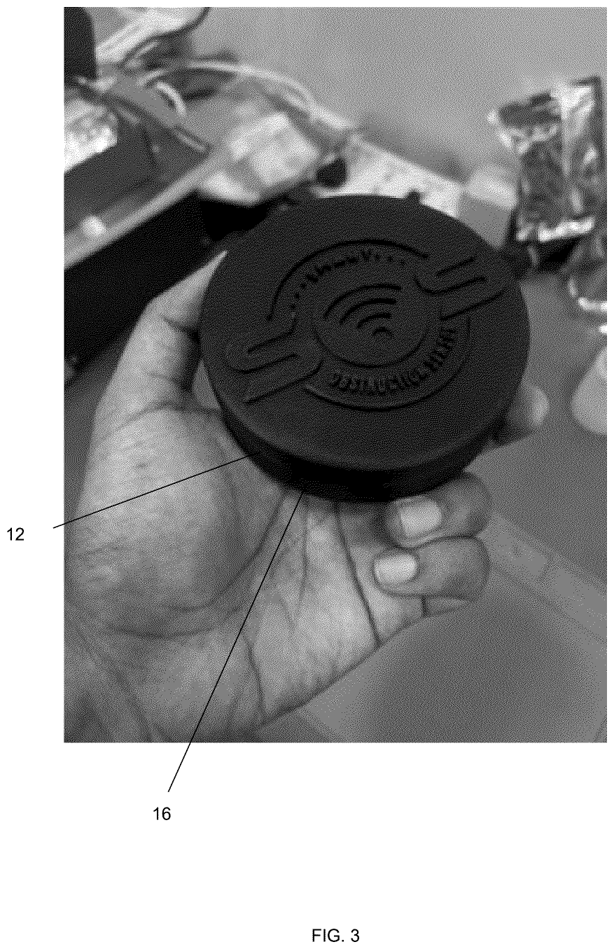

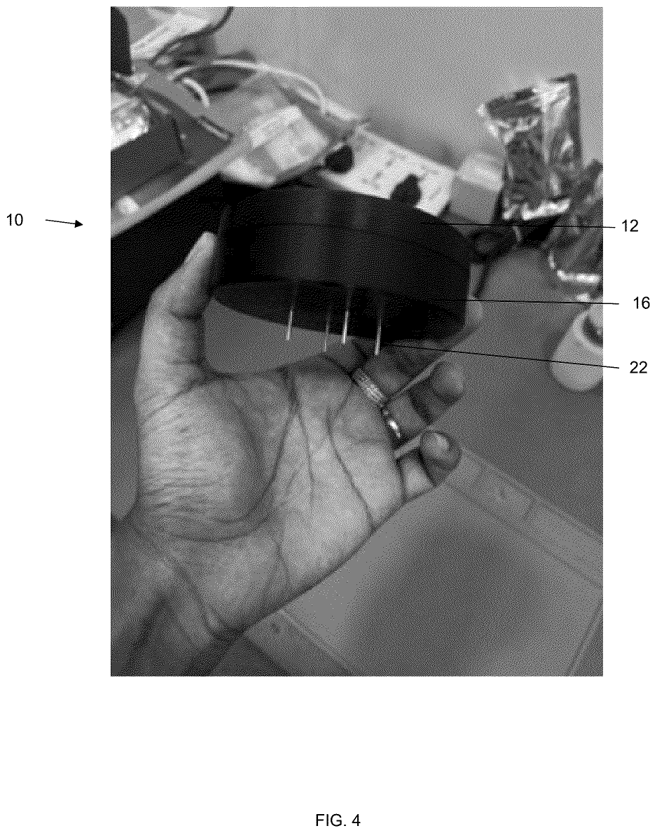

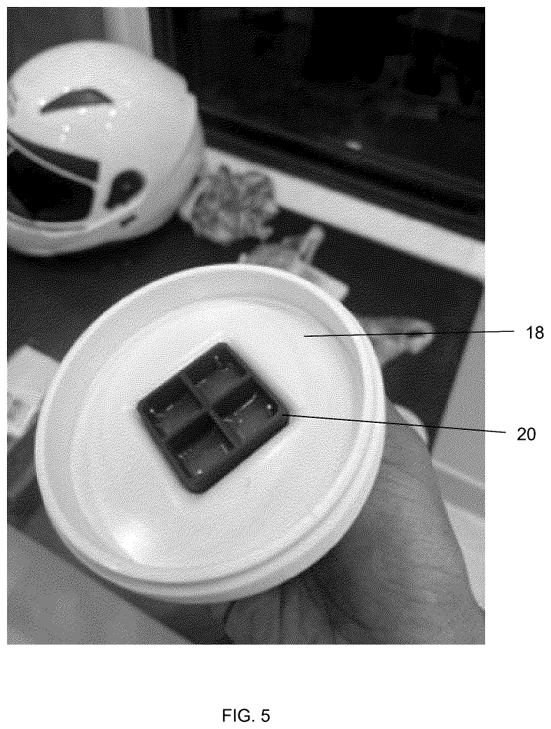

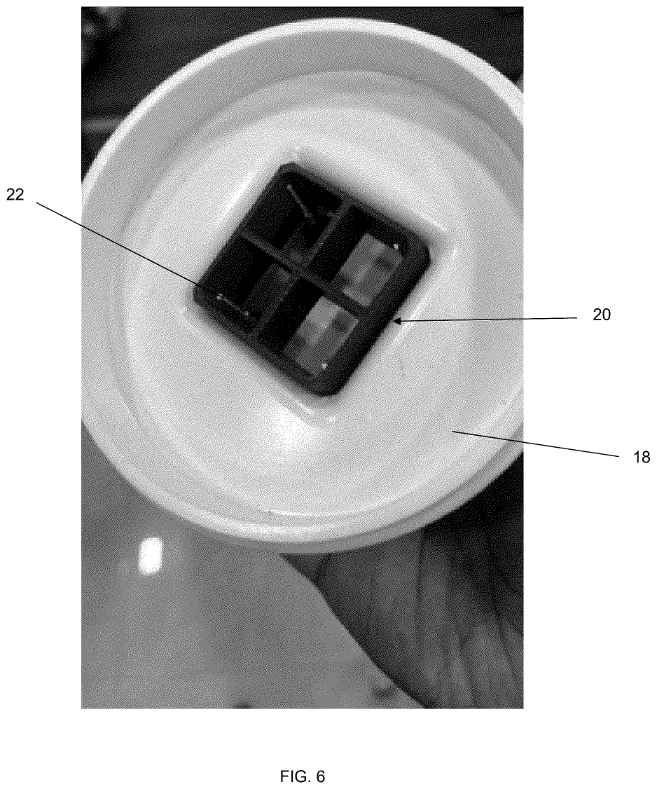

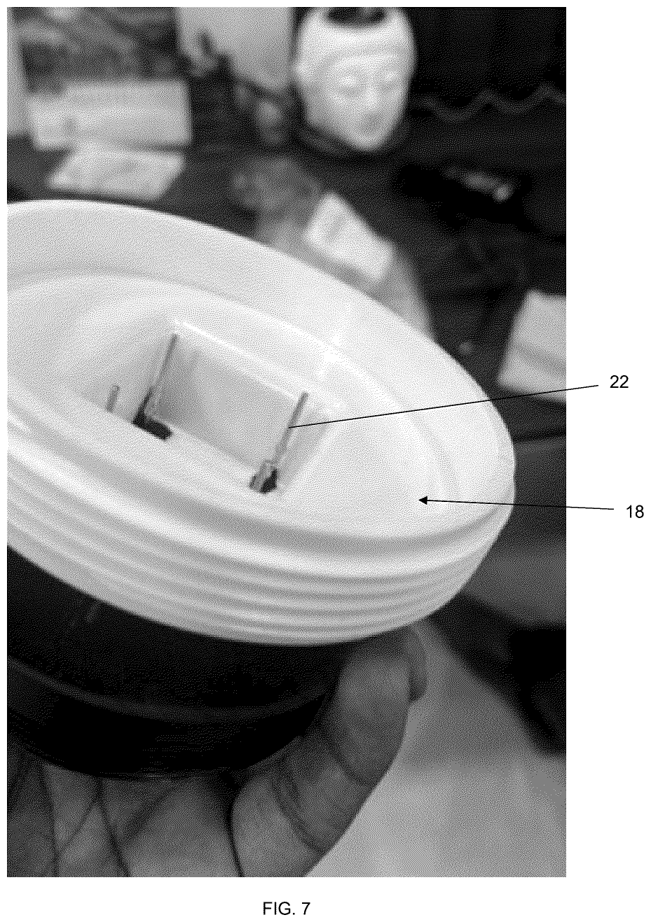

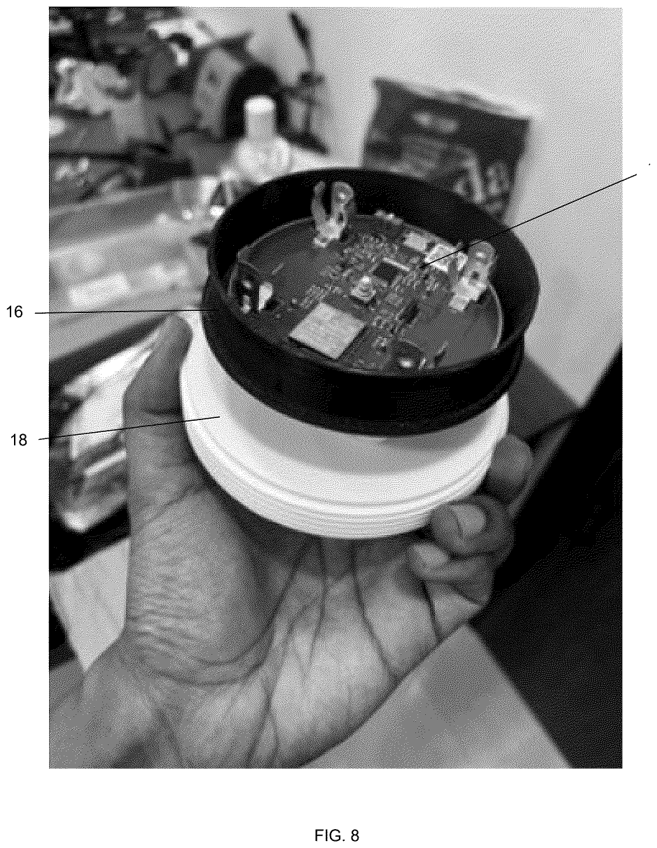

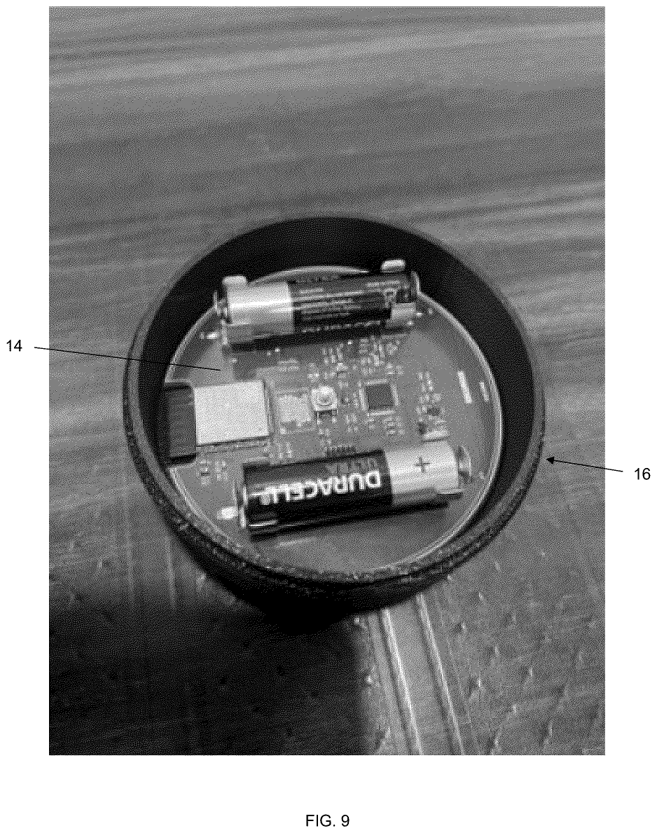

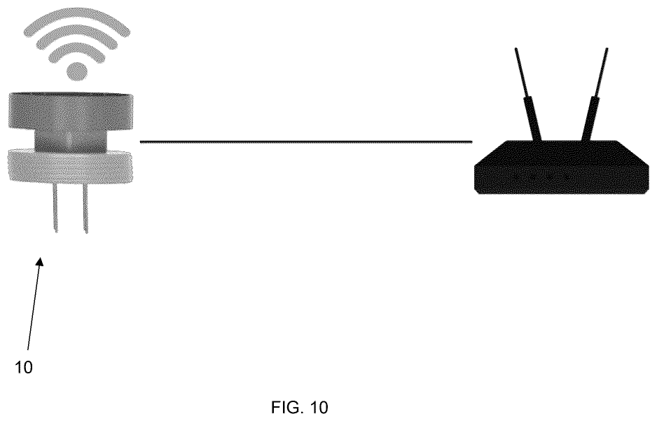

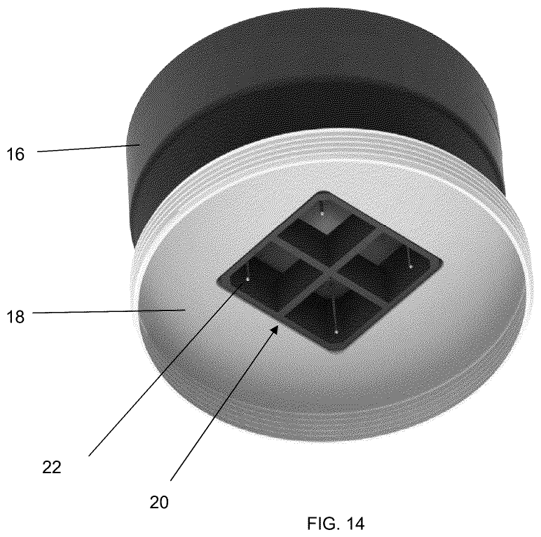

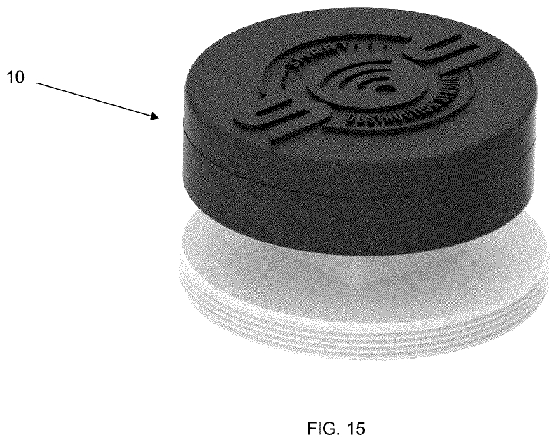

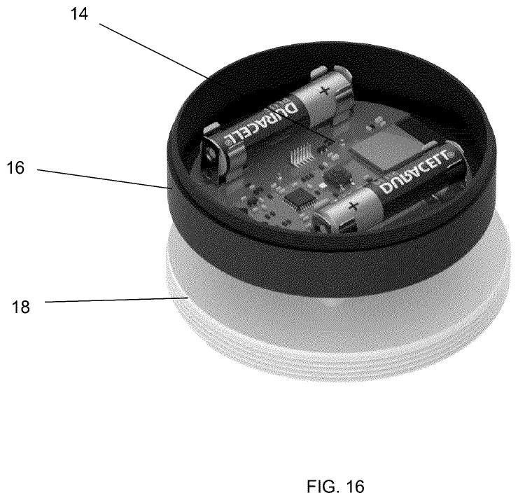

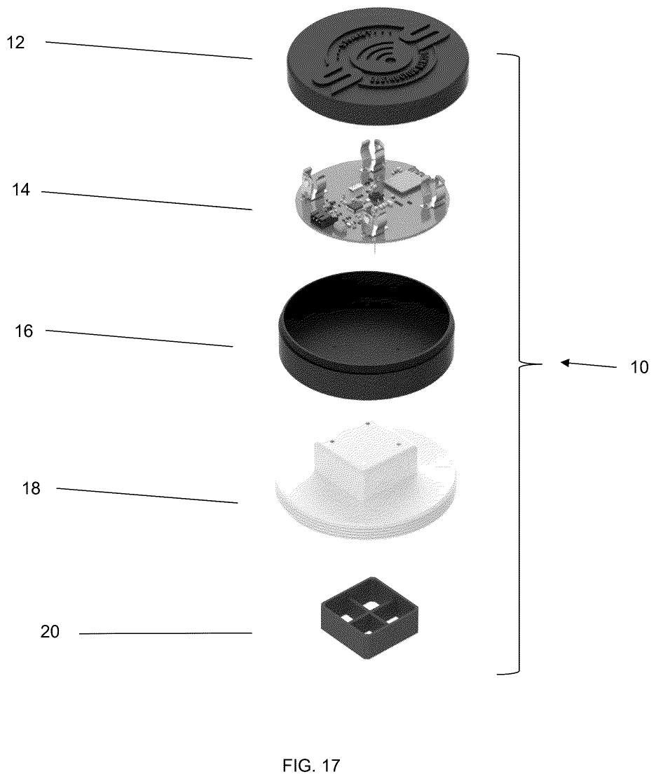

With reference to FIGS. 1-17, the preferred embodiments of the drain line alert device of the present invention may be described. Generally speaking, the present invention is directed to a drain line alert device 10 that provides alerts of drain line stoppage to avoid overflowing and flooding issues.

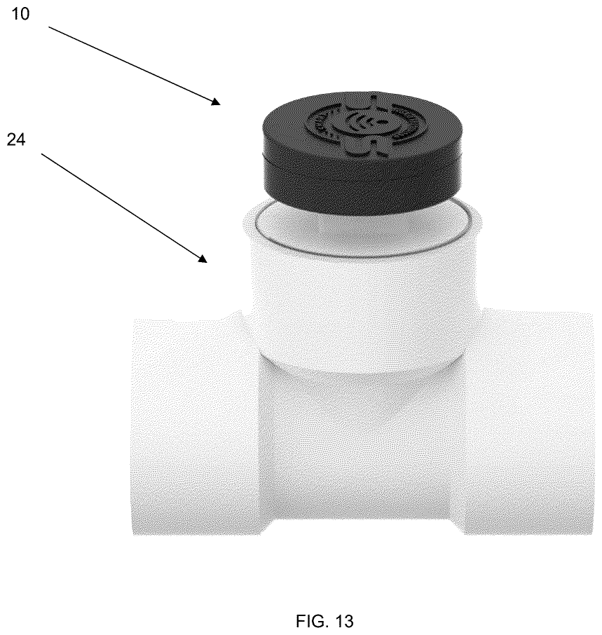

The drain line alert device 10 is essentially a wireless sensor made to detect when the sewer line is full of wastewater and about to overflow. The device 10 can be installed in any sanitary sewer system of any pipe size. It is preferably installed at the lowest point in the sanitary sewer system or sanitary branch line for earliest detection. For installation of the device 10, a standard plumbing tee 24 must be installed, and the device 10 is then simply screwed into the plumbing tee 24, as shown in FIG. 13. In another embodiment, the device 10 is attached to a removable plug on the plumbing tee 24. The device 10 has a small button inside of the device 10. The device 10 activates with a double click of the button.

The device 10 is preferably approximately 3 inches in diameter and roughly 1 inch thick.

As shown in FIG. 1, the device 10 contains the following components: an enclosure cover 12; a printed circuit board (PCB) 14; an enclosure housing 16; a plumbing fitting clean out plug 18; and a base 20 with sensor prongs 22. The enclosure cover 12 screws on and attaches to the device enclosure housing 16 to protect the PCB 14. The PCB 14 receives a signal from the base 20 with sensor prongs 22 and sends a wireless signal via short message service (SMS) or email to alert the user when the base 20 with sensor prongs 22 is submerged in water. The enclosure housing 16 contains the PCB 14. The plumbing fitting clean out plug 18 is a mounting apparatus for the device 10. The base 20 contains four plated sensor prongs 22 to detect water. When the prongs 22 of the base 20 are submerged in water, the base 20 sends a signal to the PCB 14.

The technological components are stored within the device 10. Once installed the device 10 is powered on and finds the commercial building or residential Wi-Fi. Through a mobile application, the user may enter contact information for the alert recipients. In the event of a sewer stoppage, the device 10 detects the wastewater and immediately texts and/or emails the desired point of contact instructing them to stop running water and flushing toilets to prevent an overflow. Once the line has been cleared, the device 10 resets automatically.

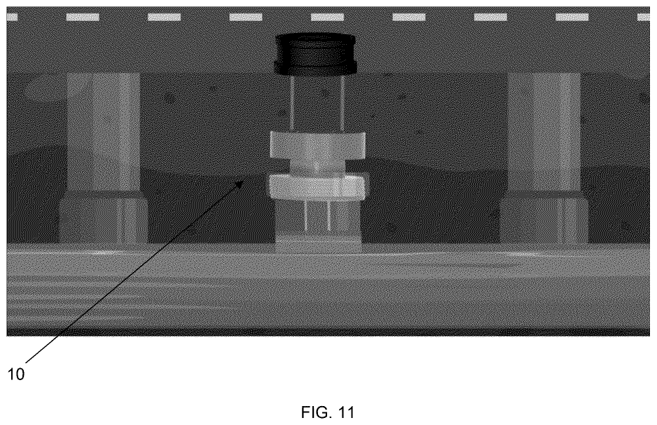

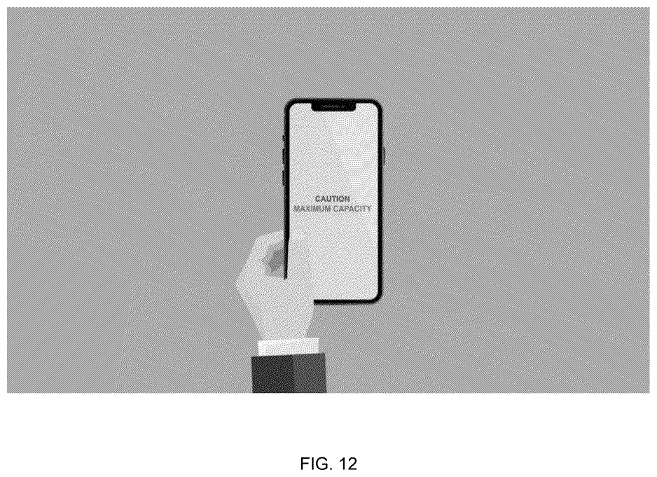

In an underground embodiment, there is a sealed unit below ground that connects with the above ground unit for all communication and power supply needs. The sensor allows water to flow unimpeded. Upon detecting a blockage, the device 10 sends a notification to the user when water backs up and contacts the prongs 22, as shown in FIGS. 11 and 12.

The present invention has been described with reference to certain preferred and alternative embodiments that are intended to be exemplary only and not limiting to the full scope of the present invention, as set forth in the appended claims.

1. A drain line alert device, comprising:
an enclosure cover;
a printed circuit board positioned in an enclosure housing, wherein said enclosure housing is connected to said enclosure cover;
a plumbing fitting clean out plug connected to a bottom surface of said enclosure housing, wherein said plumbing fitting clean out plug is connectable to a sanitary sewer system; and
a base with a plurality of sensor prongs operable for detecting water, wherein said base is connected to said plumbing fitting clean out plug, wherein said sensor prongs are in communication with said printed circuit board.

2. (canceled)

3. The drain line alert device of claim 1, wherein said sensor prongs communicate with said printed circuit board when said sensor prongs are contacted by water.

4. The drain line alert device of claim 1, wherein said plumbing fitting clean out plug is connectable a plumbing tee of said sanitary sewer system.

5. The drain line alert device of claim 1, wherein said drain line alert device is powered by a plurality of batteries.

6. The drain line alert device of claim 1, wherein said plurality of sensor prongs comprises four prongs.

7. The drain line alert device of claim 1, wherein said plumbing fitting clean out plug comprises a recess that receives said base.

8. The drain line alert device of claim 1, wherein said device is connectable to a Wi-Fi network.

9. The drain line alert device of claim 1, wherein said printed circuit board is operable to send a notification to a designated person when said plurality of prongs is contacted by water.

10. A drain line alert device, comprising:
an enclosure containing a printed circuit board;
a plumbing fitting clean out plug connected to said enclosure, wherein said plumbing fitting clean out plug is connectable to a sanitary sewer system; and
a plurality of sensor prongs extending below said plumbing fitting clean out plug, wherein said plurality of sensor prongs are operable for detecting water from said sanitary sewer system and are in communication with said printed circuit board, wherein said drain line alert device is connectable to a Wi-Fi network and is operable to send a notification to a designated person when said plurality of sensor prongs detects water.

11. The drain line alert device of claim 10, wherein said enclosure comprises an enclosure cover and an enclosure housing.

12. The drain line alert device of claim 10, wherein said plurality of sensor prongs extend from a recess in a bottom surface of said plumbing fitting clean out plug.

13. The drain line alert device of claim 10, wherein said plumbing fitting clean out plug is connectable to a plumbing tee of said sanitary sewer system.

14. The drain line alert device of claim 10, wherein said drain line alert device is powered by batteries.

15. The drain line alert device of claim 10, further comprising a power button.

16. A method of using a drain line alert device, comprising the steps of:
connecting a drain line alert device to a sanitary sewer system, wherein said drain line alert device comprises:
an enclosure containing a printed circuit board;
a plumbing fitting clean out plug connected to said enclosure; and
a plurality of sensor prongs extending below said plumbing fitting clean out plug, wherein said plurality of sensor prongs are in communication with said printed circuit board;
connecting said drain line alert device to a Wi-Fi network; and
sending a notification of a stoppage in said sanitary sewer system from said drain line alert device to a designated person if said plurality of prongs are contacted by water.

17. The method of claim 16, wherein said step of connecting said drain line alert device to said sanitary sewer system comprises the step of connecting said plumbing fitting clean out plug to a plumbing tee of said sanitary sewer system.

18. The method of claim 16, further comprising the step of resetting said drain line alert device after said stoppage in said sanitary sewer is cleared.
